(19) United States
(12) Patent Application Publication
(10) Pub. No.: US 2014/0002231 A1
(43) Pub. Date: Jan. 2, 2014

(54) COMMON MODE NOISE FILTER

(71) Applicant: SAMSUNG ELECTRO-MECHANICS CO., LTD., Suwon-si (KR)

(72) Inventors: Sang Moon LEE, Suwon-si (KR); Sung Kwon WI, Suwon-si (KR); Jun Hee BAE, Suwon-si (KR); Young Do KWEON, Suwon-si (KR); Yong Suk KIM, Suwon-si (KR)

(73) Assignee: SAMSUNG ELECTRO-MECHANICS CO., LTD., Suwon-si (KR)

(21) Appl. No.: 13/827,661

(22) Filed: Mar. 14, 2013

(30) Foreign Application Priority Data
Jun. 28, 2012 (KR) 10-2012-0070051

(51) Int. Cl. H01F 3/08

(52) U.S. Cl. CPC H01F 3/08
USPC 336/233

(57) ABSTRACT

Disclosed herein is a common mode noise filter independently including ferrite powder having pores formed in a surface thereof or including at least two kinds of ferrite powder having different particle sizes as a magnetic layer.

According to the present invention, the adhesive strength between the polymer binder and the ferrite powder that are included in the magnetic layer is improved, such that at the time of manufacturing or mounting of a chip, a defect such as a crack generated by a thermal impact due to a lack of adhesive strength between the ferrite powder and the polymer binder may be suppressed, thereby securing the reliability with respect to the thermal impact.

### CROSS REFERENCE(S) TO RELATED APPLICATIONS

This application claims the benefit under 35 U.S.C. Section 119 of Korean Patent Application Serial No. 10-2012-0070051, entitled “Common Mode Noise Filter” filed on Jun. 28, 2012, which is hereby incorporated by reference in its entirety into this application.

### BACKGROUND OF THE INVENTION

1. Technical Field

The present invention relates to a common mode noise filter.

2. Description of the Related Art

Electronic devices around us generate more or less radiation noise. Since noise freely and suddenly changes, noise immunity allowing an electronic device itself not to generate noise and preventing an electronic device from malfunctioning by external noise has been required. This is the basis of electro magnetic compatibility (EMC).

Generally, conduction noise may ‘be bypassed’ to a ground by a condenser, or ‘be absorbed’ by a resistor and a ferrite core, a chip bead, or the like, to thereby be converted into heat and then removed.

As a measure against the conduction noise, there is another important method. That is a method of “reflecting” noise current using a property of an inductor. The inductor allows a direct current to easily flow, but allows an alternate current not to easily flow due to increased impedance (resistance for the alternate current). However, as a transferring type of conduction noise, there are two types; a differential mode type and a common mode type. Therefore, a measure against noise according to a type of noise is required. If the type of the noise is not confirmed, even though a noise suppression component is added to a circuit, the noise may further increase.

The common mode is a conduction mode in which the noise transfers in the same direction with respect to an outward path and a return path. The common mode noise may be generated by impedance unbalance of a wiring system. In addition, the higher a frequency is, the more significant the common mode noise is. In addition, since the common mode noise is also transferred to the ground, or the like, to return while drawing a large loop, various noise disturbances may be generated even in a distant electronic device.

Therefore, in a digital device, a measure against the common mode noise is regarded as important as or more important than a measure against the differential mode noise.

A common mode noise filter 10 has a structure in which a ferrite substrate 11 is installed with an insulation layer 13 having internal coil conductors 12 formed therein, wherein the internal coil conductors 12 are connected to via electrodes (not shown), and then the substrate is connected to external terminal electrodes 14 at an outer peripheral surface thereof, as shown in FIG. 1. In addition, an inner portion of the coil conductor 12 is provided with an opening part 15 penetrating through the insulation layer 13, and the opening part 15 includes a magnetic layer 16 filled with a magnetic material and formed therein.

A structure of FIG. 1 viewed from above is shown in FIG. 2.

The magnetic layer 16 is made of a ferrite composite formed by mixing a ferrite with a polymer binder, wherein the ferrite uses one kind of powder or two kinds of powers having a different size. However, in the case in which spherical ferrite powder are used in order to increase a filling ratio of the ferrite composite, at the time of manufacturing or mounting of a chip, a defect such as a crack may be generated by thermal impact due to a lack of adhesive strength between the ferrite and the polymer binder.

In addition, in order to improve a permeability value, a method of increasing a particle size of the ferrite, a method of decreasing an amount of polymer binder, or a method of raising a temperature at the time of molding, or the like, is used. However, when the particle size is increased, high frequency characteristics are deteriorated, and when the amount of polymer binder is decreased, insulation and withstanding voltage characteristics of a green compact may be deteriorated. Further, the method of raising a temperature may cause deterioration of workability, a high cost of the equipment, and a problem in reliability of a filter.

### SUMMARY OF THE INVENTION

An object of the present invention is to overcome a problem of winded or laminated common noise filter. According to the present invention, a thin-film type common mode noise filter having a precisely fine line-width, excellent connectivity between upper and lower patterns to easily form an internal circuit pattern, and excellent connectivity with an external electrode may be provided.

Another object of the present invention is to provide a thin-film type common mode noise filter having excellent electrical characteristics and reliability.

According to an exemplary embodiment of the present invention, there is provided a common mode noise filter including ferrite powder having pores formed in a surface thereof as a magnetic layer.

The pore formed in a surface of the ferrite powder may have a size of 100 to 1000 nm.

The ferrite powder may have an average particle size of 10 to 50 μm.

The ferrite powder may have a spherical shape.

The ferrite power may be prepared by mixing raw material powder to spray-dry the mixture and calcining the spray-dried mixture for 50 to 90 minutes at 800 to 900° C.

The ferrite powder may be at least one kind selected from a group consisting of Fe₂O₃, NiO, CuO, ZnO, MnO, Co₃O₄, Bi₂O₃, and Ti.

The magnetic layer may include at least one kind of polymer binder selected from a group consisting of an epoxy resin, a polyimide resin, a polyamide resin, and a polyaniline resin.

The ferrite power and the polymer binder may be mixed at a weight ratio of 7:1 to 10:1 to form the magnetic layer.

According to another exemplary embodiment of the present invention, there is provided a common mode noise filter including at least two kinds of ferrite powder having pores formed in a surface thereof and having different particle sizes as a magnetic layer.

The ferrite powder may include a first particle(A_{L}) having an average particle size of 10 to 50μm and a second particle(As) having an average particle size of 0.01 to 9 μm.

The first and second particles A_{L} and As may have average particle sizes at a ratio of 3:1 to 10:1.

The pore formed in a surface of the first particle may have a size of 100 to 1000 nm, and the pore formed in a surface of the second particle may have a size of 10 to 100 nm.

The first particle and second particle may have a content ratio of 3:1 to 10:1.

The ferrite powder may have a spherical shape.

The first particle may be prepared by mixing a raw material powder to spray-dry the mixture and calcining the spray-dried mixture for 50 to 90 minutes at 800 to 900° C., and the second particle may be prepared by mixing a raw material powder to spray-dry the mixture and calcining the spray-dried mixture for 10 to 40 minutes at 800 to 900° C.

The ferrite powder may be at least one kind selected from a group consisting of Fe₂O₃, NiO, CuO, ZnO, MnO, Co₃O₄, Bi₂O₃, and Ti.

The magnetic layer may include at least one kind of polymer binder selected from a group consisting of an epoxy resin, a polyimide resin, a polyamide resin, and a polyaniline resin.

The ferrite power and the polymer binder may be mixed at a weight ratio of 7:1 to 10:1 to form the magnetic layer.

### BRIEF DESCRIPTION OF THE DRAWINGS

FIGS. 1 and 2 are views showing a structure of a common mode noise filter according to the related art;

FIGS. 3 and 4 are views showing a structure of a common mode noise filter according to the present invention;

FIG. 5 is a view showing a structure of a ferrite powder according to an exemplary embodiment of the present invention;

FIG. 6 is a scanning electron microscope micrograph of a particle size of a ferrite powder prepared according to Example 2 of the present invention; and

FIG. 7 is a view showing a process of manufacturing the common mode noise filter according to the exemplary embodiment of the present invention.

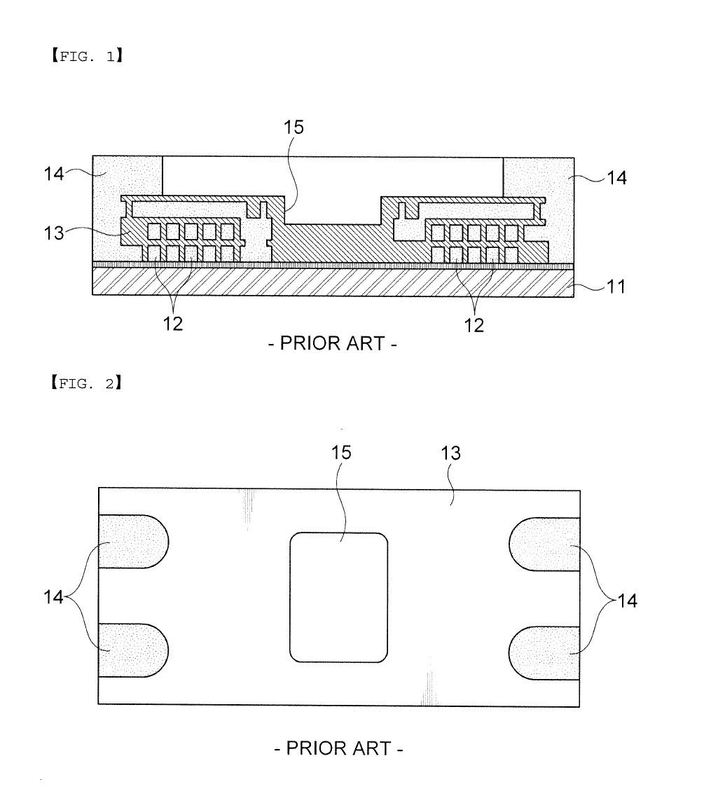

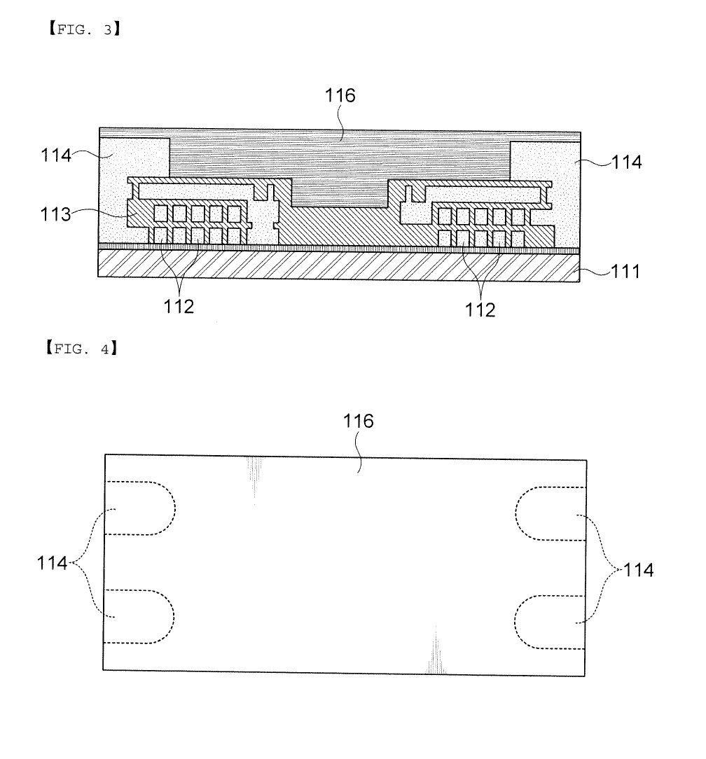

### DESCRIPTION OF THE PREFERRED EMBODIMENTS

Hereinafter, preferred embodiments of the present invention will be described in detail with reference to the accompanying drawings.

Terms used in the present specification are for explaining the embodiments rather than limiting the present invention. Unless explicitly described to the contrary, a singular form includes a plural form in the present specification. Also, used herein, the word “comprise” and/or “comprising” will be understood to imply the inclusion of stated constituents, steps, numerals, operations and/or elements but not the exclusion of any other constituents, steps, operations and/or elements.

A common mode noise filter according to the present invention includes a magnetic layer including spherical ferrite powder having pores formed in a surface thereof.

FIG. 3 is a view showing a structure of the common mode noise filter 100 according to the exemplary embodiment of the present invention. Referring to FIG. 3, the common mode noise filter 100 is configured to include a plurality of insulation layers 113 configuring of a laminated body formed on a substrate 111, internal electrode coils 112 included in the plurality of insulation layers 113, external electrode terminals 114 connected to end portions of the internal electrode coil 112, and a magnetic layer 116 formed on a surface of the laminated body.

In the present invention, as the ferrite powder among materials of the magnetic layer 116, a kind of particle having pores formed in a surface thereof, or at least two kinds of particles having pores formed in a surface thereof and having different sizes may be used.

As the substrate 111 used in the common mode noise filter according to the exemplary embodiment of the present invention, a general ferrite substrate may be used, and a material of the ferrite is not particularly limited.

The plurality of insulation layers 113 are laminated on the ferrite substrate 111 to form the laminated body, and each of the insulation layers 113 include the internal electrode coils 112 formed therein. The internal electrode coils 112 of each of the insulation layers 113 are connected to each other by via electrodes adjacent thereto (not shown).

The insulation layer 113 serves to insulate the internal electrode coils 112 from each other and to planarize a surface in which the internal electrode coils 112 are formed. As a material of the insulation layer 113, a polymer resin having excellent electrical or magnetic insulation characteristics and excellent formability, for example, an epoxy resin, a polyimide resin, or the like, may be used, but is not particularly limited thereto.

Further, the internal electrode coil 112 formed in each of the insulation layer 113 may be made of copper (Cu), aluminum (Al), or the like, having excellent conductivity and formability and be formed using an etching method using photolithography, an additive method (a plating method), or the like. However, the method of forming the internal electrode coil is not particularly limited thereto.

The opening part penetrating through each of the insulation layers 113 is formed at a central portion of the insulation layer 113, that is, inner portions of each of the internal electrode coils 112, and the internal electrode coils 112 formed in each of the insulation layers 113 are electrically connected to each other by the via electrodes of each of the insulation layers.

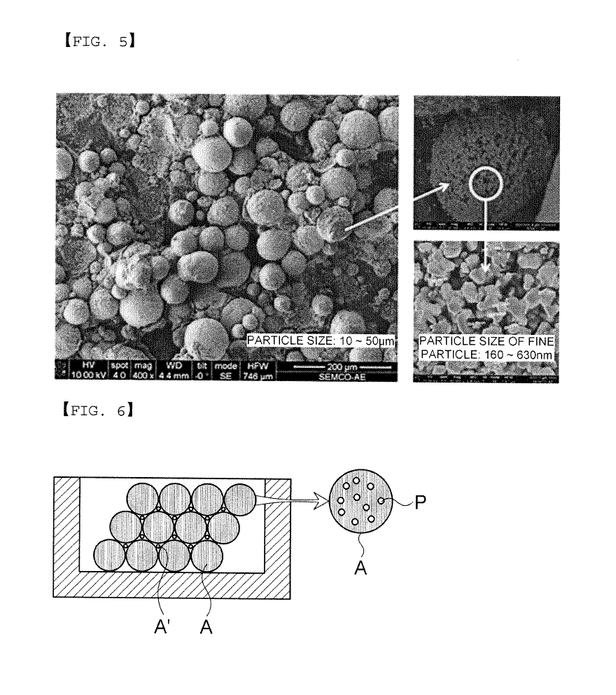

In addition, each end portion of the internal electrode coils 112 is connected to the external electrode terminals 114, and four external electrode terminals 114 are formed at both sides of an outer peripheral surface of the laminated body. FIG. 3 viewed from above is shown in FIG. 4.

Further, the noise filter according to the exemplary embodiment of the present invention has a structure in which the magnetic layer 116 is formed on the surface of the laminated body. The magnetic layer 116 according to the exemplary embodiment of the present invention may include ferrite powder, a polymer binder, and other additives.

In the present invention, particularly, the ferrite power having pores formed in a surface thereof may be used as the ferrite powder. A size of the pore formed in the surface of the ferrite powder may be 100˜1000 nm. In the case in which the pore has a size smaller than 100 nm, the ferrite powder does not have a sufficient surface area, such that dispersibility may not be sufficiently improved, and in the case in which the pore has a size larger than 1000 nm, the ferrite powder may absorb the polymer binder at the time of dispersion. Since the surface area of the ferrite powder may be increased by forming the pore in the surface of the ferrite powder as described above, the dispersibility with the mixed polymer binder may be improved.

Further, it is preferable in view of improvement of permeability that the ferrite powder used in the present invention has an average particle size of 10˜50 μm.

In addition, since spherical ferrite particles may be well dispersed, it is preferable that the ferrite power according to the present exemplary embodiment of the present invention has a spherical shape.

The ferrite powder having pores formed in the surface thereof according to the present invention may be prepared as follows. Each of the raw material powder configuring the ferrite powder are mixed with each other for 7 to 10 hours using an attrition mill, and then the mixture is spray-dried at 200 to 400° C. Next, the spray-dried mixture is calcined for 50 to 90 minutes at about 800 to 900° C., such that the ferrite power may be prepared.

The ferrite powder prepared under the above-mentioned conditions has an average particle size of about 10 to 50 μm, and when magnified, fine pores are formed in the surface thereof. Therefore, the spherical ferrite particle having a wide surface area may be prepared under the above-mentioned conditions.

In addition, the ferrite powder according to the present invention may be prepared by mixing at least one material selected from a group consisting of Fe₂O₃, NiO, CuO, ZnO, MnO, Co₃O₄, Bi₂O₃, and Ti.

Further, the magnetic layer 116 according to the present invention may include the polymer binder together with the ferrite power having the pore formed in the surface thereof, wherein the polymer binder may be at least one kind selected from a group consisting of an epoxy resin, a polyimide resin, a polyamide resin, and a polyaniline resin and have an excellent thermal stability.

It is preferable in view of the dispersibility and process capability that the ferrite power and the polymer binder are mixed at a weight ratio of 7:1 to 10:1 to form the magnetic layer according to the embodiment of the present invention.

In addition, the magnetic layer according to the present invention may include a general additive, such as a dispersant.

It is preferable in view of wetting property and defoaming property that the magnetic layer according to the exemplary embodiment of the present invention has a thickness of 50 to 100 μm.

In addition, a common mode noise filter according to another exemplary embodiment of the present invention has a structure as shown in FIG. 3, and the material of the magnetic layer 116 includes at least two kinds of ferrite powder having pores formed in a surface thereof and having different particle sizes.

That is, at least two kinds of ferrite powder having different particle sizes are mixed with each other to be used, such that spaces between ferrite powders having a large size are effectively filled with ferrite powder having a small size. Therefore, substantially, two kinds of ferrite powder are dispersed and contact areas between the ferrite powder and the mixed polymer binder is increased, such that the dispersibility may be improved and reliability with respect to thermal impact may be improved.

According to the exemplary embodiment of the present invention, the ferrite powder may include a first particle A having an average particle size of 10 to 50 μm and a second particle A′ having an average particle size of 0.01 to 9 μm, as shown in FIG. 5. In addition, when the average particle size of the first particle having a large size is A_{L} and the average particle size of the second particle having a small size is As, a ratio of A_{L} to As may be 3:1 to 10:1. In the case in which the ratio of A_{L} and As is out of the range, a filling ratio is reduced, such that the permeability may be reduced.

In the ferrite powder according to the exemplary embodiment of the present invention, the first and second particles A and A′ include pores P formed in the surfaces thereof at a predetermined size, respectively, and the second particles A′ having a relatively small size are uniformly dispersed between the first particles A having a relatively large size, as shown in FIG. 5.

Further, since spherical ferrite particles may be well dispersed, it is preferable that the ferrite power according to the present exemplary embodiment of the present invention has a spherical shape.

According to the exemplary embodiment of the present invention, the pores formed in the surface of the first particle having an average particle size of 10 to 50 μm may have a size of 100 to 1000 nm, and the pores formed in the surface of the second particle having an average particle size of 0.01 to 9 μm may have a size of 10 to 100 nm.

According to the exemplary embodiment of the present invention, a mixing ratio of the first particle to second particle may be 3:1 to 10:1. In the case in which the mixing ratio is out of the range, the permeability may be reduced.

The first particle may be prepared through a process of mixing raw material powder configuring the ferrite powder to spray-dry the mixture and a process of calcining the spray-dried mixture for 50 to 90 minutes at 800 to 900° C.

In addition, the second particle may be prepared through a process of mixing raw material powder configuring the ferrite powder to spray-dry the mixture and a process of calcining the spray-dried mixture for 10 to 40 minutes at 800 to 900° C.

In the case in which the calcining condition is not satisfied, the size of the pore formed in the surface may be out of the range, or the average particle size may be changed, such that a surface area and the dispersibility may be deteriorated. The average particle size and the size of the pore may be adjusted by adjusting the calcining condition.

The ferrite powder according to the exemplary embodiment of the present invention may include at least one material selected from a group consisting of Fe₂O₃, NiO, CuO, ZnO, MnO, Co₃O₄, Bi₂O₃, and Ti.

Further, the magnetic layer 116 according to the present invention may include the polymer binder together with the ferrite power having the pore formed in the surface thereof, wherein the polymer binder may be at least one kind selected from a group consisting of an epoxy resin, a polyimide resin, a polyamide resin, and a polyaniline resin and have an excellent thermal stability.

It is preferable in view of dispersibility and process capability that the ferrite power and the polymer binder are mixed at a weight ratio of 7:1 to 10:1 in the magnetic layer.

In addition, the magnetic layer according to the present invention may include a general additive, such as a dispersant.

FIG. 7 shows a process of manufacturing the common mode noise filter according to the exemplary embodiment of the present invention. Referring to FIG. 7, a first insulation layer is formed on an insulation film that are made of ferrite substrate, and internal electrode coils are formed in the first insulation layer and a second insulation layer and are electrically connected to each other through via electrodes. An outer peripheral end of the internal electrode coil is connected to an external electrode terminal through an outlet terminal.

Next, internal electrode coils of the second insulation layer and a third insulation layer are electrically connected to each other through via electrodes, and the internal electrode coils formed in each of the insulation layers are connected to the external electrode terminal. In addition, a magnetic layer is formed on the outermost insulation layer, and a final common mode noise filter may be manufactured by a dicing process.

The magnetic layer according to the exemplary embodiment of the present invention may be formed independently using one kind of ferrite power having pores formed in a surface thereof or using at least two kinds of ferrite power having a different particle size and include a polymer binder and an additive. The ferrite powder may have the pores formed in the surface thereof through a process of mixing the powder under a predetermined condition, a process of spray-drying the mixture, and a process of calcining of the spray-dried mixture.

It is preferable in view of wetting property and defoaming property that the magnetic layer according to the exemplary embodiment of the present invention has a thickness of 50 to 100 μm.

Hereinafter, Examples of the present invention will be described. The following Examples are only to exemplify the present invention, and the scope of the present invention should not be interpreted to being limited to these Examples. Further, although the following Examples exemplify the present invention using specific compounds, it is obvious to those skilled in the art that the same or similar effect may also be generated in the case of using equivalents to the specific compounds.

### EXAMPLE 1

The common mode noise filter was manufactured through the following process shown in FIG. 7. A first insulation layer made of an epoxy resin was formed on an insulation film made of a ferrite substrate, and internal electrode coils were formed on the first insulation layer using a copper (Cu) metal. In addition, internal electrode coils were formed on a second insulation layer made of an epoxy resin using a copper (Cu) metal. An additional insulation layer may be formed by repeating a process of forming the internal electrode coils on each of the insulation layers. Further, the internal electrode coils formed on each of the first and second insulation layers were electrically connected to each other through via electrodes.

Outer peripheral ends of the internal electrode coils were connected to external electrode terminals through outlet terminals, and internal electrode coils of the second insulation layer and a third insulation layer were electrically connected to each other through via electrodes, and the internal electrode coils formed in each of the insulation layer were connected to the external electrode terminals.

In addition, a magnetic layer was formed on the outermost insulation layer at a thickness of 100 μm. Ferrite used in the magnetic layer was obtained as follows. Fe—Ni—Zn—Cu Based ferrite powder were mixed for 9 hours using Attrition mill, and then were spray-dried at 300° C.

Next, the spray-dried ferrite powder were calcined for 50 minutes at 900° C., such that Fe—Ni—Zn—Cu Based ferrite power including pores formed in a surface thereof at a size of 100 nm and having an average particle size of 4000 nm was prepared.

The ferrite powder prepared as described above and polyimide polymer binder were mixed at a ratio of 9:1 with each other, and the mixture was applied, such that the magnetic layer was formed. Next, a final common mode noise filter was manufactured through a dicing process.

### Example 2

In Example 2, the common mode noise filter was manufactured by the same processes as those in Example 1 except that two kinds of particles having a different particle size were mixed with each other and used as the ferrite powder in the magnetic layer and an epoxy resin was used as the polymer binder in Example 2, wherein a ratio of average particle sizes of a first particle (A_{L}) to a second particle (As) was a weight ratio of 8:1.

Among the two kinds of ferrite powder, the first particle including pores formed in a surface thereof at a size of 100 nm is a Fe—Ni—Zn—Cu based ferrite power prepared by calcination for 50 minutes at 900° C., and the second particle including pores formed in a surface thereof at a size of 10 nm is a Fe—Ni—Zn—Cu based ferrite power prepared by calcination for 30 minutes at 900° C., wherein a ratio of average particle sizes of the first particle (A_{L}) to the second particle (As) was a weight ratio of 8.25:1.

The two kinds of ferrite powder and a polyimide polymer binder were mixed at a ratio of 9:1, such that a magnetic layer having a thickness of 100 μm was formed.

### Experimental Example 1

### Confirmation of Particle Size of Ferrite Powder

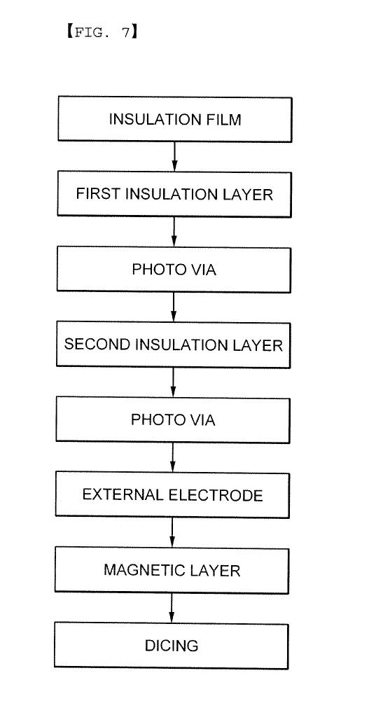

A particle size of the ferrite powder prepared in Example 2 was confirmed using a scanning electron microscopy (SEM). Results of the confirmation were shown in FIG. 6.

Referring to FIG. 6, it may be appreciated that a first particle having an average particle size of 10 to 50 μm and a second particle having a fine average particle size of 0.01 to 9 μm are formed through a preparing process of Example 2.

In addition, it may be appreciated that the second particles are uniformly distributed empty spaces between the first particles. Therefore, at the time of preparing a solution for forming a magnetic layer according to the present invention, dispersibility of the first and second particles may be improved and adhesive strength with the polymer binder to be mixed may increase.

### Experimental Example 2

The permeability of noise filters manufactured from the ferrite particles of Example 1 and Example 2 were measured. The measurement results were shown in the following g Table 1.

TABLE 1

| | | Ratio of Ferrite | |
|---|---|---|---|
| | Binder | Particle to Binder | Permeability |
| Example 1-1 | Epoxy Resin | 9:1 | 13.15 |
| Example 1-2 | Epoxy Resin | 9:1 | 14.2 |
| Example 2-1 | Epoxy Resin | 9:1 | 23.4 |
| Example 2-2 | Epoxy Resin | 9:1 | 24.7 |

It may be appreciated from the results of the above Table 1 that the common mode noise filter including the ferrite powder (Examples 1-1 and 1-2) having pores formed in a surface thereof or two kinds of ferrite powder (Examples 2-1 and 2-2) having a different particle size according to the present invention as the magnetic layer may have excellent permeability.

As described above, according to the present invention, as materials of the magnetic layer of the common mode noise filter, spherical ferrite powder having pores formed in a surface thereof is independently used or ferrite powder having a size smaller than that of the ferrite powder is mixed with the above-mentioned ferrite powder to thereby be used, such that the dispersibility may be improved, thereby improving the adhesive strength between the ferrite powder and the polymer binder to be mixed.

In addition, according to the present invention, the adhesive strength between the polymer binder and the ferrite powder is improved, such that at the time of manufacturing or mounting of a chip, a defect such as a crack generated by thermal impact due to a lack of adhesive strength between the ferrite powder and the polymer binder may be suppressed, thereby securing the reliability with respect to the thermal impact.

Further, the spherical ferrite powder included in the magnetic layer according to the present invention may be easily dispersed due to a difference in a particle size, such that the permeability of the common mode noise filter may be improved, thereby manufacturing the thin-film type common mode noise filter having a fine line-width and a relatively thick thickness.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A common mode noise filter comprising ferrite powder having pores formed in a surface thereof as a magnetic layer.

2. The common mode noise filter according to claim 1, wherein the pore formed in a surface of the ferrite powder has a size of 100 to 1000 nm.

3. The common mode noise filter according to claim 1, wherein the ferrite powder has an average particle size of 10 to 50 μm.

4. The common mode noise filter according to claim 1, wherein the ferrite powder has a spherical shape.

5. The common mode noise filter according to claim 1, wherein the ferrite power is prepared by mixing the ferrite powder to spray-dry the mixture and calcining the spray-dried mixture for 50 to 90 minutes at 800 to 900° C.

6. The common mode noise filter according to claim 1, wherein the ferrite powder is at least one selected from a group consisting of Fe₂O₃, NiO, CuO, ZnO, MnO, Co₃O₄, Bi₂O₃, and Ti.

7. The common mode noise filter according to claim 1, wherein the magnetic layer includes at least one kind of polymer binder selected from a group consisting of an epoxy resin, a polyimide resin, a polyamide resin, and a polyaniline resin.

8. The common mode noise filter according to claim 7, wherein the ferrite power and the polymer binder are mixed at a weight ratio of 7:1 to 10:1 to form the magnetic layer.

9. A common mode noise filter comprising at least two kinds of ferrite powder having pores formed in a surface thereof and having different particle sizes as a magnetic layer.

10. The common mode noise filter according to claim 9, wherein the ferrite powder includes a first particle(A_{L}) having an average particle size of 10 to 50 μm and a second particle(As) having an average particle size of 0.01 to 9 μm.

11. The common mode noise filter according to claim 10, wherein the first and second particles A_{L} and As have average particle sizes at a ratio of 3:1 to 10:1

12. The common mode noise filter according to claim 10, wherein the pore formed in a surface of the first particle has a size of 100 to 1000 nm, and the pore formed in a surface of the second particle has a size of 10 to 100 nm.

13. The common mode noise filter according to claim 10, wherein the first particle and second particle have a content ratio of 3:1 to 10:1.

14. The common mode noise filter according to claim 9, wherein the ferrite powder has a spherical shape.

15. The common mode noise filter according to claim 10, wherein the first particle is prepared by mixing a raw material to spray-dry the mixture and calcining the spray-dried mixture for 50 to 90 minutes at 800 to 900° C., and
the second particle is prepared by mixing a raw material to spray-dry the mixture and calcining the spray-dried mixture for 10 to 40 minutes at 800 to 900° C.

16. The common mode noise filter according to claim 9, wherein the ferrite powder is at least one selected from a group consisting of Fe₂O₃, NiO, CuO, ZnO, MnO, Co₃O₄, Bi₂O₃, and Ti.

17. The common mode noise filter according to claim 9, wherein the magnetic layer includes at least one kind of polymer binder selected from a group consisting of an epoxy resin, a polyimide resin, a polyamide resin, and a polyaniline resin.

18. The common mode noise filter according to claim 17, wherein the ferrite power and the polymer binder are mixed at a weight ratio of 7:1 to 10:1 to form the magnetic layer.
